(19) United States
(12) Patent Application Publication
(10) Pub. No.: US 2010/0195781 A1
(43) Pub. Date: Aug. 5, 2010

(54) NEUTRON BEAM RADIATION APPARATUS

(75) Inventors: Michael Paul, Jerusalem (IL); Morris Srebnik, Mevaseret Zion (IL); Alex Arenshtam, Kiryat Gat (IL); Shlomi Halfon, Tel Aviv (IL); Dany Kijel, Rishon L'Zion (IL); Itzhak Polacheck, Jerusalem (IL); Avraham Rubinstein, Jerusalem (IL); Doron Steinberg, Jerusalem (IL)

Correspondence Address: Allan C. Entis Ph.D., Intellectual Property Ltd., 6 Raoul Wallenberg Street, Ramat Hachayal, Tel Aviv, 69719, IL

(73) Assignees: Yissum Research Development Company of the Hebrew University of Jerusalem Ltd., Jerusalem (IL); Soreq Nuclear Research Center, Yavne (IL); Hadasit Medical Research Services & Development Ltd., Jerusalem (IL)

(21) Appl. No.: 12/668,026

(22) PCT Filed: Jul. 10, 2008
(86) PCT No.: PCT/IL2008/000959

§ 371 Date: Feb. 21, 2010

Related U.S. Application Data
(60) Provisional application No. 60/929,700, filed on Jul. 10, 2007.

(51) Int. Cl. G21G 1/06; B05B 1/00

(52) U.S. Cl. 376/185; 239/589

(57) ABSTRACT

A liquid lithium jet nozzle comprising: an inlet through which liquid lithium flows into the nozzle; an inlet flow channel that receives liquid lithium that flows into the nozzle via the inlet and shapes the flowing liquid lithium to flow in a thin film; and a flow region that receives flowing liquid lithium shaped by the flow channel and in which the liquid lithium flows with at least one large surface of the film exposed.

### RELATED APPLICATIONS

The present application claims benefit under USC 119(e) of U.S. application Ser. No. 60/929,700 filed on Jul. 10, 2007 entitled “Neutron Source and System and Method Employing the Same”, the disclosure of which is incorporated herein by reference.

### FIELD

The invention relates to apparatus for performing neutron radiation therapy and methods for tailoring neutron beams for therapeutic purposes.

### BACKGROUND

The use of neutron radiation for cancer therapy has been known and practiced from about the time that E. O. Lawrence, the inventor of the cyclotron (1932), and his brother John, a physician, treated their mother's cancer with neutron radiation in 1938. A form of neutron radiation therapy, referred to as Boron Neutron Capture Therapy (BNCT), has recently been the subject of increased attention for application using linear accelerators.

In BNCT, boron is preferentially concentrated in a target tissue, usually a malignancy, of a patient using a suitable “carrier compound” comprising boron, and a beam of neutrons is aimed to enter the patient's body along a direction that intersects the target tissue and irradiates the concentrated boron with neutrons. An energy spectrum of neutrons in the entering beam is configured so that after propagating through body tissue to a depth at which the target tissue is located, a relatively large number of the neutrons in the beam are thermalized by moderation processes in the traversed body tissue and have kinetic energy equal to about 0.025 eV. For many medical applications and depths of target tissue in a patient's body neutrons in the entering beam are epithermal neutrons having energy in a range from 0.5 keV to about 10 keV. Boron has a relatively large capture cross section for thermal neutrons and when a boron atom captures a neutron, an a particle and a lithium nucleus are produced with emission of a gamma ray in about 94% of the decays.

Typically, the energies of the released α particles range from about 1.47 Mev to about 1.78 Mev. At these α particle energies and corresponding energies for the lithium ion, the α and lithium ions are highly ionizing and interact strongly with tissue into which they are released depositing substantially all their kinetic energy in relatively short distances from about 5 μm to 9 μm from where they are created. The deposited energy generally causes severe damage and usually death to the tissue in which it is deposited.

Since distance over which the energy is deposited is relatively small, damage is highly localized to tissue in which the boron carrier compound is concentrated. In fact, the range over which the α particles generated in the reaction ¹⁰B(n, α)⁷Li deposit their energy (5 μm to 9 μm) is about equal to a characteristic dimension of a living cell. As a result, the deposited energy damages substantially only a cell in which the interaction that produces the α particle takes place and BNCT is considered a therapy, which if properly performed, is highly selective of tissue it is intended to damage. To properly perform the therapy with relatively little damage to surrounding non-target tissue, it is considered that a concentration of boron in a target tissue should be about 4 times that of non-target surrounding tissue. Various boron carrier compounds for use in concentrating boron in a target tissue are known in the art. Among these compounds, by way of example, are amine-boranes boron-ethers, boronic acids, boronic esters, boronic acids, acrylate-boron copolymers, and boron containing polysaccharides. The choices are sufficiently numerous and varied so that generally, highly specific ligands can be produced that are tailored for preferential uptake by a given target tissue. Boron comprising compounds suitable for use in BNCT are described in WO 2007/032004 and WO 2007/032005, the disclosures of which are incorporated herein by reference.

Typically, neutron beams for BNCT are provided by nuclear reactors. However, nuclear reactors are generally large and expensive and the use of nuclear reactors for BNCT limits availability of BNCT therapy to a relatively few large institutions that have a reactor, or are close to one that is available. Recent advances in accelerator technology have made it plausible to use relatively small, inexpensive accelerators to produce neutron beams for medical purposes. A small, modern and relatively inexpensive linear accelerator can be used to accelerate ions, optionally protons, which can be focused on a suitable target so that the ions collide and interact with nuclei in the target to create neutrons.

Li is considered an optimum target for production of neutrons suitable for BNCT by the reaction ⁷Li(p,n)⁷Be. For proton energies in a range from about 1.9 Mev to about 2.5 Mev, neutrons generated by the reaction ⁷Li(p,n)⁷Be have average energies in a range from about 4 keV to about 550 keV. These neutron energies are sufficient so that energy of the neutrons can be adjusted by suitable moderation for use in BNCT. Generally, neutrons in a beam for use in BNCT should have energy greater than thermal energy (i.e. greater than 0.025 eV) so that upon reaching a target tissue in a patient's body, energy they lose to tissue they traverse on the way to the target results in their being thermalized at the target. For typical depths of target tissue in patients' bodies, neutrons in the beam should have epithermal energies in a range of from about 0.5 eV to about 10 keV. Epithermal neutrons, have reduced radiological risks, and do not generally cause substantial damage to tissue on their way to targeted tissues and before their thermalization.

Whereas other targets such as ⁹Be, and ¹³C are useable to produce neutrons in reactions ⁹Be(p,n) or ⁹Be(d,n) and ¹³C(d,n) respectively, ⁷Li is considered to be a particularly advantageous target. For a given intensity of ion beam, ⁷Li provides a relatively large yield of neutrons at desirable energies and energy of the bombarding protons is moderate and readily provided by a relatively inexpensive linear accelerator. However, Li is a difficult material to use for a target. The metal is highly reactive and has a relatively low melting temperature of 181° C. and a low thermal conductivity of 84.4 W/(mK) at 300° K. To produce a neutron beam having sufficient intensity for BNCT use, a beam of protons having intensity of at least about 3 mA is considered necessary to irradiate a Li target and produce sufficient number of neutrons. For this intensity beam, and energies of protons noted above to produce neutrons in the reaction ⁷Li(p,n)⁷Be, a Li target would be destroyed by heat deposited in the target by the beam unless specific measures are undertaken to dissipate the heat.

To dissipate heat and maintain integrity of a lithium target irradiated by an intense ion beam, liquid lithium targets rather than solid lithium targets have been proposed and developed. For a system comprising a liquid lithium target that interacts with an ion beam, the liquid lithium is heated and pumped through a circulation system so that the liquid lithium flows into and passes through an interaction region in which the beam is illuminated by the ion beam. Excess heat generated in the lithium by interaction with the beam is transported with the flowing lithium to a heat exchanger where the heat is dissipated.

Claude B. Reed et al in an article entitled “A 20 kW beam-on-target test of a high power liquid lithium target for RIA”; Nuclear Physics A 746 (2004) 161c-165c, describes a windowless liquid lithium target system planned for use at Argonne National Laboratory as a target for heavy ion beams produced by the Rare Isotope Accelerator (RIA). The system is designed to pump liquid lithium into an evacuated beam pipe in which an ion beam propagates, and form a jet of liquid lithium that flows perpendicular to the ion beam through an interaction region intersected by the beam. The beam appears to have a cross section having dimensions of 5 mm by 10 mm. An electron beam was used to “conduct a 20 kW test to demonstrate that power densities equivalent to a 200-kW RIA uranium beam deposited in the first 4 mm of a flowing lithium jet can be handled by the windowless target design without disrupting either the 5 mm×10 mm flowing lithium jet target or the beam line vacuum.” The article notes that “The 20 kW heat load was deposited by a 1 mm dia. 20 mA beam of 1 Mev electrons” and that “at a jet velocity of 10 m/s a 20 kW, 1 mm diameter beam will produce about 90° C. surface temperature rise across the beam spot . . . ”

Mizuho Ida et al, in an article entitled “Thermal-hydraulic characteristics of IFMIF liquid lithium target”; Fusion Engineering and Design 63-64 (2002) 333-342; describe a windowless liquid lithium target having relatively large dimensions for use with deuteron beams to produce neutrons for testing fusion reactor materials. The flowing liquid lithium in an interaction region with a deuteron beam is described as having thickness parallel to the deuteron beam of between 19 and 25 cm, width of about 26 cm and flow rate of up to about 20 m/s.

### SUMMARY OF THE INVENTION

An aspect of some embodiments of the invention relates to providing a neutron production system, hereinafter referred to as a “neutron factory”, comprising a linear accelerator and an improved lithium target for use in producing neutrons suitable for neutron capture therapy (NCT).

An aspect of some embodiments of the invention relates to providing an improved liquid lithium target system configured to provide a windowless liquid lithium jet that flows through an interaction region with a proton beam provided by the accelerator.

The inventors have noted that protons having energies in a range from about 1.9 MeV to about 2.5 Mev that are used for neutron production by interaction with lithium via the process ⁷Li(p,n)⁷Be are substantially completely absorbed over a path length in the Li of less than about 200 μm. For the purposes of neutron production for BNCT from protons therefore, a lithium jet target characterized by a relatively small dimension parallel to the beam direction may be used. A relatively thin lithium target can be advantageous in reducing parasitic gamma-ray production in the lithium target by protons that have not generated neutrons and have had their energy reduced below threshold for the reaction ⁷Li(p,n)⁷Be by interaction with the lithium.

The inventors have further determined that for proton beam intensities sufficient to provide a neutron flux satisfactory for many BNCT applications, required dissipation of heat generated in a thin lithium jet target can be managed by flow rates of the lithium provided by a relatively small liquid lithium pumping and flow system.

In some embodiments of the invention, thickness of the lithium jet parallel to the beam direction is less than or equal to about 3 mm. Optionally, the thickness is less than less than or equal to about 2 mm. In some embodiments of the invention, thickness of the lithium jet is less than or equal to about 1 mm. In some embodiments of the invention thickness of the lithium jet is less than or equal to about 100 μm. Optionally, the thickness is less than or equal to about 50 μm. In some embodiments of the invention, the thickness is less than about 20 μm. Optionally the thickness is equal to about 10 μm.

To dissipate heat for a proton beam interacting with a liquid lithium jet, in accordance with an embodiment of the invention, the liquid lithium target system flows lithium in the jet at a flow rate equal to or greater than about 20 m/s. Optionally, the flow rate is greater than or equal to about 25 m/s. In some embodiments of the invention flow rate is equal to or greater than about 30 m/s. Flow rate is determined by a rate at which energy density is deposited by protons in the liquid lithium in the jet and a constraint, that to maintain target integrity, lithium in the beam pipe in which the proton beam propagates should not be allowed to “boil” or “bubble”. For a vacuum in the beam pipe maintained at a pressure of 10⁻⁵ Torr, lithium boils at a temperature of about 350° C.

By way of example, in some embodiments of the invention, a BNCT neutron factory operates with a proton beam characterized by energy of about 2 Mev, intensity of about 3 mA, and Gaussian spatial distribution with a at 2 mm. Such a proton beam may be used to provide a neutron beam by interaction with lithium that is advantageous for BNCT therapies. In accordance with an embodiment of the invention, to dissipate heat for such a proton beam, advantageously the liquid lithium target system is configured to flow lithium in the jet at a flow rate equal to or greater than about 20 m/s.

Useful proton beam intensities in a range between about 5 mA to about 10 mA is generally considered to be advantageous for practical BNCT. Such beam intensities are readily provided by relatively small and inexpensive linear accelerators that are presently available. A lithium target system in accordance with an embodiment of the present invention that flows lithium through an interaction zone at a flow rate greater than about 30 m/s is expected to be suitable for a practical BNCT neutron factory.

Because a neutron factory and liquid lithium target system in accordance with an embodiment of the invention, are relatively small and inexpensive, they can make neutron beams for BNCT therapies, and the therapies, more readily available to a larger community than they are today.

It is noted that whereas a liquid lithium target system and neutron factory, in accordance with embodiments of the invention, have been described with particular reference to BNCT, practice of the invention is not limited to BNCT. A lithium target and neutron factory in accordance with an embodiment of the invention are useable generally for neutron capture therapy, for production of neutrons by interaction of lithium with ion beams, and for processes for which such neutrons are useable.

There is therefore provided in accordance with an embodiment of the invention, a liquid lithium jet nozzle comprising: an inlet through which liquid lithium flows into the nozzle; an inlet flow channel that receives liquid lithium that flows into the nozzle via the inlet and shapes the flowing liquid lithium to flow in a thin film; and a flow region that receives flowing liquid lithium shaped by the flow channel and in which the liquid lithium flows with at least one large surface of the film exposed.

Optionally, the nozzle is formed having first and second surfaces that face each other and define a dimension of the inlet flow channel. Optionally, distance between the first and second surfaces decrease with distance from the inlet. Additionally or alternatively, the first surface is an internal surface of a wall of the jet nozzle.

In accordance with some embodiments of the invention, the second surface is an internal surface of a wall of the nozzle.

In accordance with some embodiments of the invention, the nozzle comprises a septum and the second surface is a surface of the septum. Optionally, the septum is curved and the second surface is concave.

In accordance with some embodiments of the invention, a dimension of a cross section of the inlet flow channel perpendicular to a direction of flow of liquid lithium in the flow channel increases with distance from the inlet along a flow path of liquid lithium in the nozzle.

In accordance with some embodiments of the invention, area of a cross section of the inlet flow channel perpendicular to a direction of flow of liquid lithium in the flow channel decreases with distance from the inlet along a flow path of liquid lithium in the nozzle.

In accordance with some embodiments of the invention, the jet nozzle comprises a third surface located in the flow region that contacts the flowing film of liquid lithium. Optionally, the third surface is concave.

In accordance with some embodiments of the invention, thickness of the film is less than or equal to about 3 mm. Optionally, thickness of the film is less than or equal to about 2 mm. Optionally, thickness of the film is less than or equal to about 1 mm. Optionally, thickness of the film is less than or equal to about 100 μm. Optionally, thickness of the film is less than or equal to about 50 μm. Optionally, thickness of the film is less than or equal to about 20 μm. Optionally, thickness of the film is equal to about 10 μm.

There is further provided in accordance with an embodiment of the invention, a liquid lithium target system comprising: a jet nozzle according to an embodiment of the invention; and a liquid lithium pump for pumping liquid lithium to the inlet of the jet nozzle.

Optionally, the pump pumps liquid lithium so that it flows through the flow region at a flow rate equal to or greater than about 20 m/s. Optionally, the pump pumps liquid lithium so that it flows through the flow region at a flow rate equal to or greater than about 25 m/s. Optionally, the pump pumps liquid lithium so that it flows through the flow region at a flow rate equal to or greater than about 30 m/s.

There is further provided in accordance with an embodiment of the invention, a neutron factory for producing neutrons by interaction of accelerated ions with liquid lithium, the neutron factory comprising: a liquid lithium target system according to an embodiment of the invention; and an accelerator that generates a beam of ions that is incident on liquid lithium flowing in the flow region of the jet nozzle. Optionally, the accelerator comprises a linear accelerator. Additionally or alternatively, the beam has intensity equal to or greater than about 3 mA. Additionally or alternatively, the beam has intensity equal to or greater than about 5 mA.

### BRIEF DESCRIPTION OF FIGURES

Non-limiting examples of embodiments of the present invention are described below with reference to figures attached hereto. In the figures, identical structures, elements or parts that appear in more than one figure are generally labeled with a same symbol in figures in which they appear. Dimensions of components and features shown in the figures are generally chosen for convenience and clarity of presentation and are not necessarily shown to scale. The figures are listed below.

FIG. 1 schematically shows a perspective view of a liquid lithium target system, in accordance with an embodiment of the invention;

FIGS. 2A and 2B schematically show enlarged views of a liquid jet flow nozzle comprised in the liquid lithium target system shown in FIG. 1, in accordance with an embodiment of the invention; and

FIGS. 3A and 3B schematically show enlarged views of another liquid jet flow nozzle, in accordance with an embodiment of the invention.

### DETAILED DESCRIPTION OF EXEMPLARY EMBODIMENTS

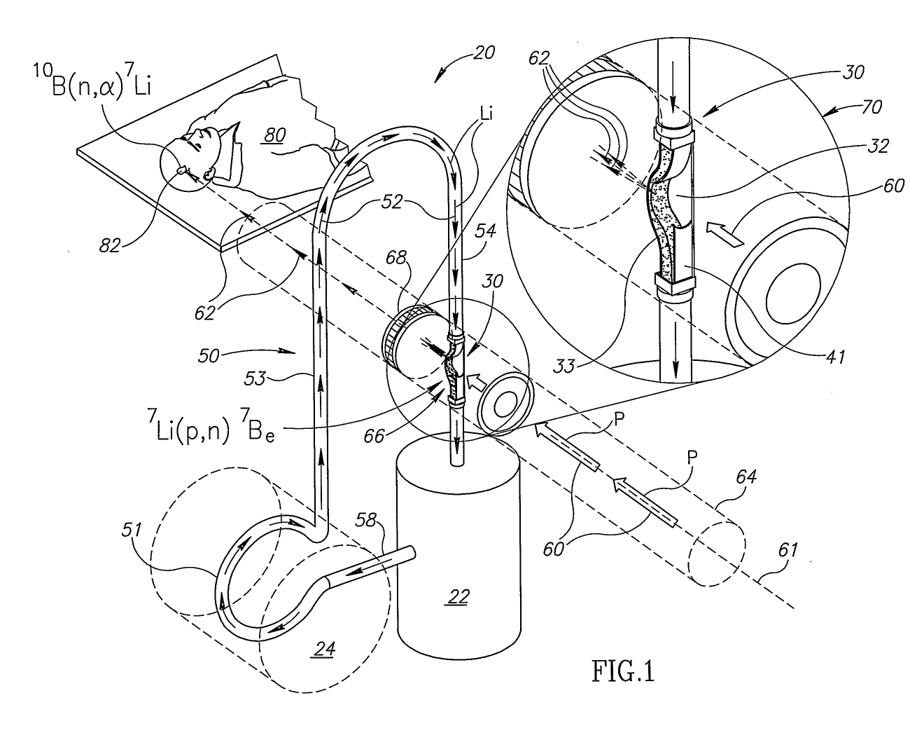

FIG. 1 schematically shows a perspective view of a liquid lithium target system 20 being used with a proton beam represented by block arrows 60 to produce a neutron beam represented by arrows 62, in accordance with an embodiment of the invention. Neutrons in neutron beam 62 are produced in the interaction ⁷Li(p,n)⁷Be when protons in proton beam 60 collide with lithium atoms in an interaction region of lithium target system 20. Neutron beam 62 is used for providing BNCT therapy to treat a patient 80, in accordance with an embodiment of the invention. For convenience of presentation, reference numerals 60 and 62 that refer to the proton and neutron beams respectively are also used to refer to protons and neutrons in the beams. Proton beam 60 is optionally generated by a linear accelerator (not shown).

By way of example, patient 80 is being treated for a glioma 82 in the brain and it is assumed that boron has been concentrated in the glioma by uptake of a suitable boron comprising ligand introduced into the patient's body. Neutrons in neutron beam 60 upon incidence with glioma 82 are captured by boron atoms concentrated in the glioma and produce in the interaction ¹⁰B(n,α)Li, highly ionizing α particles and Li ions that destroy glioma tissue.

Liquid lithium target system 20 optionally comprises a lithium tank 22, a pump 24 shown in dashed lines, a lithium jet nozzle 30 and a circulation pipe array 50. Lithium circulating in pipe array 50 is schematically represented by arrows 52. Lithium jet nozzle 30, which is shown partially cutaway in FIG. 1, is formed having an opening 32 and is located inside a beam pipe 64 in which proton beam 60 propagates along a beam line represented by a dashed line 61. The lithium jet nozzle is positioned so that opening 32 faces upstream and protons in proton beam 60 can enter the nozzle and interact with lithium flowing in an interaction region 33 of the nozzle 30 to produce neutrons via the reaction ⁷Li(p,n)⁷Be without first passing through another material. Optionally, lithium jet nozzle 30 is mounted in a pipe housing 66 that couples to beam pipe 64 and comprises a moderator 68 that moderates neutrons produced in interaction region 33. An inset 70 in FIG. 1 shows an enlarged view of jet nozzle 30.

Lithium tank 22 stores liquid lithium that circulates in target system 20. In addition to storing liquid lithium the tank optionally performs a plurality of different functions for target system 20 and comprises apparatus (not shown) for performing the functions. In an embodiment of the invention lithium tank 22 comprises a heating unit for melting solid lithium, a heat exchanger for dissipating excess heat generated by interaction of liquid lithium with proton beam 60 and a filtering system for removing Beryllium that accumulates in the liquid lithium as a result of the interaction ⁷Li(p,n)⁷Be with the proton beam that produces neutrons 62. Any of various methods and devices known in the art may be used to provide functions performed by lithium tank 22, and whereas the lithium tank is described as comprising the devices, they may of course be “independent” devices that are not comprised in the tank.

Pump 24 is optionally an electromagnetic pump that couples to liquid lithium that flows in a “pump loop” 51 that is part of flow pipe array 50. Electromagnetic pumps for pumping conductive liquids are known and pump may be any suitable such pump known in the art.

Loop 51 and pump 24 receive liquid lithium from lithium tank 22 via a feed pipe 58. The pump pumps the liquid lithium optionally upwards through a riser pipe 53 to a nozzle feed pipe 54 that provides the liquid lithium to jet spray nozzle 30. In accordance with an embodiment of the invention, jet nozzle 30 is configured so that it accelerates flow velocity of liquid lithium that it receives and directs the accelerated liquid lithium to flow in a relatively thin “sheet of lithium through interaction region 33. After passing through lithium jet nozzle 30, liquid lithium returns to tank 22 where excess heat in the lithium is removed by the heat exchanger and the lithium is filtered to remove beryllium in the lithium. The filtered and cooled lithium is stored in tank 22 until it is recirculated through pipe system 50 by pump 24.

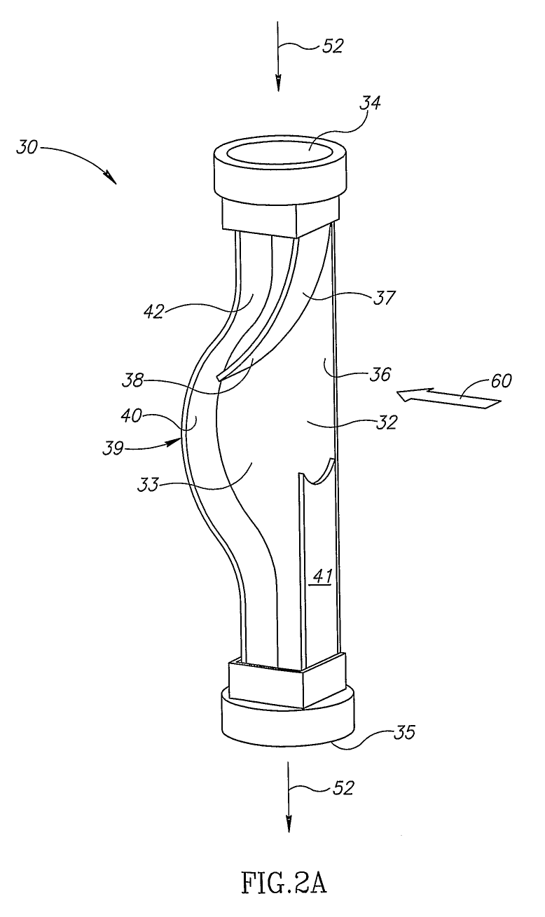

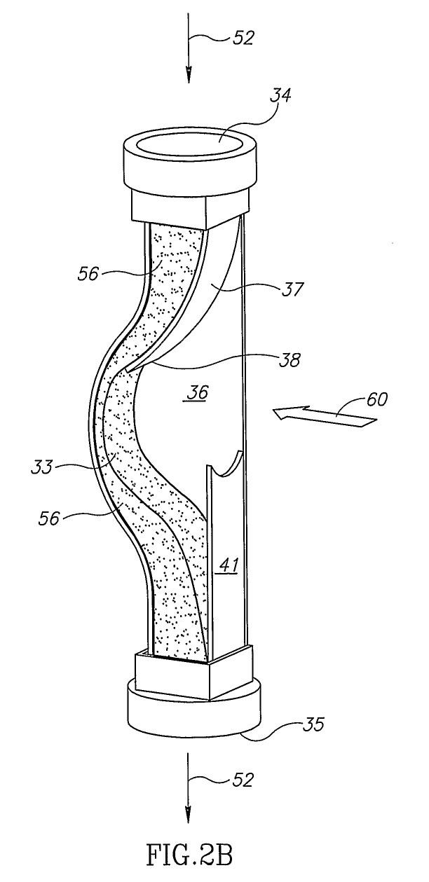

FIG. 2A is an enlarged perspective view of liquid lithium jet nozzle 30 that shows details of the nozzle construction, in accordance with an embodiment of the invention. FIG. 2B schematically shows lithium, represented by shaded region 56 flowing in the jet nozzle shown in FIG. 1A. A block arrow 60 in the figures represents proton beam 60 and is used for convenience to reference position of features of the nozzle and upstream and downstream directions. Arrows 52 indicate direction of flow of lithium.

Jet nozzle 30 is formed having an inlet port 34 and an outlet port 35 through which liquid lithium respectively enters and exits the nozzle, and two, optionally planar, side walls 36, one of which is not shown so that internal features of the nozzle are visible. The nozzle comprises a curved inlet septum 37 that is convex on its upstream side and has a lip 38. A back wall 39 facing septum 37 has a curved region 40 that is concave on its upstream side. An optionally planar front wall 41 extends part way from the region of outlet port 35 towards inlet port 34 to leave opening 32 though which beam 60 enters nozzle 30.

Septum 37 and back wall 39 cooperate to form a lithium entry flow channel 42 that narrows with distance from inlet port 34, and as a result accelerates flow velocity of liquid lithium that enters the nozzle. After passing septum lip 38 liquid lithium flows in a relatively thin sheet of liquid metal along concave portion 40 of back wall 39 through interaction region 33 of the nozzle for which there is no intervening material between the liquid lithium and proton beam 60 when the beam and nozzle are properly aligned.

By way of a numerical example, in an embodiment of the invention, width of nozzle 30 between planar side walls 36 is about 18 mm, and inlet and outlet ports 34 and 35 have diameter of about 25.4 mm. Entry flow channel 42 has a maximum distance between back wall 39 and septum 37 equal to about 25 mm, and distance between septum lip 38 and back wall 39 parallel to proton beam 60 is equal to about 1.5 mm. Thickness of liquid lithium flowing along concave portion 40 of back wall 39 in interaction region 33 is about 1.5 mm for a flow velocity of about 20 m/s.

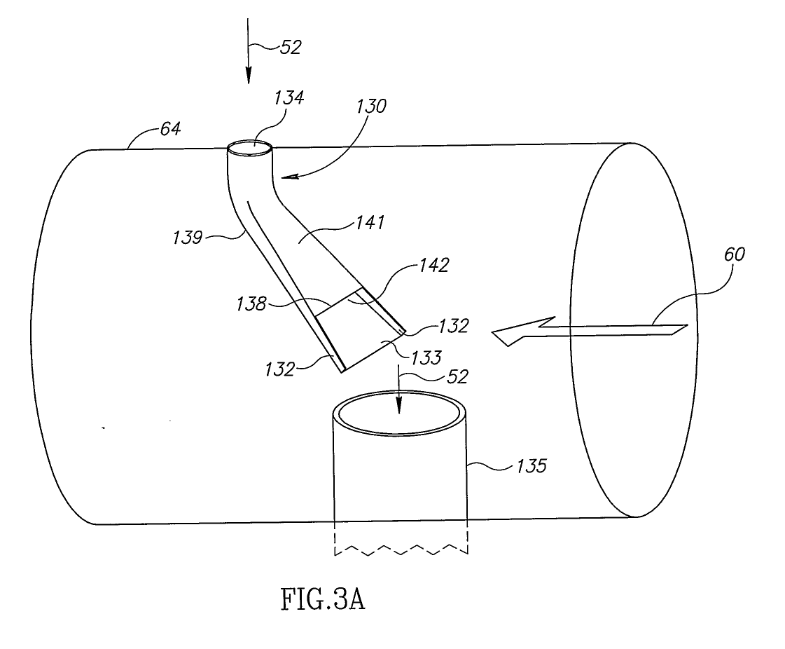

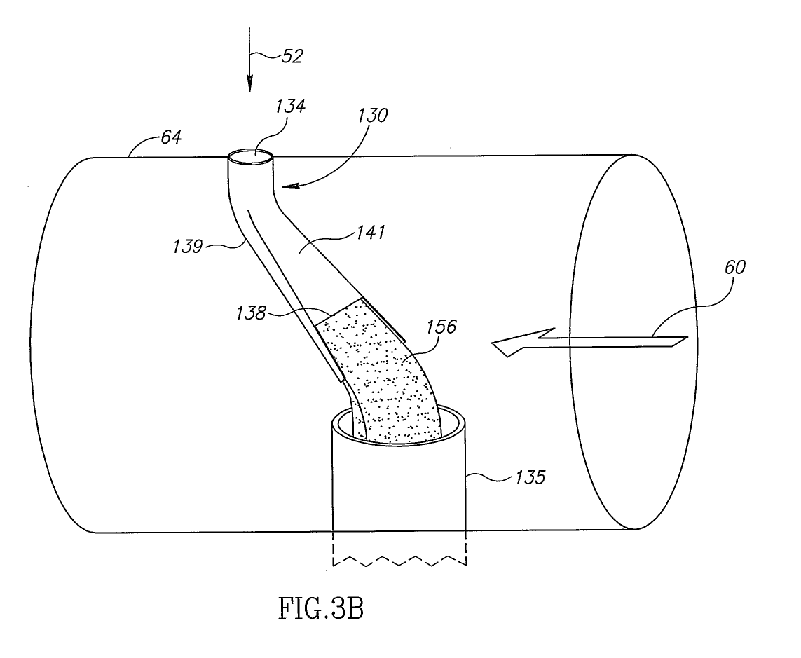

FIGS. 3A and 3B schematically show a liquid lithium jet nozzle 130 in accordance with another embodiment of the invention. As in FIGS. 2A and 2B a block arrow 60 indicates beam direction and arrows 52 indicate liquid lithium flow. FIG. 3B schematically shows liquid lithium jet nozzle 130 with liquid lithium flow shown by a shaded region 156. Nozzle 130 is shown mounted in a portion of a beam pipe 64.

Liquid lithium jet nozzle 130 is formed having an optionally circular inlet orifice 134 through which liquid lithium enters the jet nozzle, and an outlet collection tube 135 through which liquid lithium that flows through the nozzle exits beam pipe 64. Liquid lithium that enters nozzle 130 flows to a “spatula” entry flow channel 142 through which the liquid lithium flows to pass though an interaction region 133 of the nozzle. Spatula flow channel 142 is formed by upstream and downstream, optionally planar, walls 141 and 139 respectively and optionally planar edge walls 132. Upstream wall 141 has an optionally straight lip 138 that defines an outlet of the spatula inlet flow channel through which liquid lithium flows into interaction region 133.

In accordance with an embodiment of the invention, distance between upstream and downstream walls 141 and 139 decreases with distance from inlet orifice 134 along a direction of flow of lithium from the inlet orifice, and distance between sidewalls 132 increases with distance from the orifice. Cross section of spatula flow channel 142 is therefore, optionally, substantially rectangular, and has a ratio of length (measured parallel to upstream and downstream walls 141 and 139) to width that increases with distance from inlet orifice 134. In some embodiments of the invention, area of the cross section of spatula flow channel 142 is substantially constant. Optionally, area of the cross section decreases with distance from inlet port 134.

As a result of the change in shape of the cross section of spatula flow channel 142, in accordance with an embodiment of the invention, liquid lithium that enters jet nozzle 130 is shaped into a thin film of flowing lithium, indicated by shaded region 156 in FIG. 3B, when it reaches and flows through interaction region 133. To aid in maintaining integrity and lamellar flow of the film of lithium flowing in interaction region 133, downstream wall 139 is oriented so that momentum of the flowing lithium, and gravity, tend to press the film to the downstream wall. In some embodiments of the invention thickness of the liquid lithium film is less than about 100 μm. Optionally, thickness of the film is less than about 50 μm. Preferably, thickness is less than about 20 μm.

It is noted that protons having energy between about 2 Mev produce neutrons by the interaction ⁷Li(p,n)⁷Be over a path length of less than about 20 μm in lithium. Protons that survive propagation over a path length of 10 μm without producing neutrons have their energy reduced by inelastic scattering to an energy at which they are no longer effective in producing neutrons. However, the surviving protons do produce gamma rays through interaction with lithium that contaminate the neutron beam generated by the non-surviving neutrons. Therefore to reduce production of gamma rays it can be advantageous to have a lithium jet that has a relatively small dimension parallel to a proton beam with which it reacts in an interaction region of the jet and the beam.

In accordance with an embodiment of the invention therefore, a jet nozzle, such as jet nozzle 130 that provides a lithium jet having thickness less than about 200 μm is used with a suitable absorber (not shown in FIG. 3B) that absorbs protons that pass through the lithium jet. The absorber is preferably made of a high atomic-number element to reduce nuclear interaction between protons having residual energy after passing through the lithium jet target and to reduce production of gamma rays by the protons. The absorber is also configured to dissipate heat generated by the protons that enter the absorber.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The invention has been described with reference to embodiments thereof that are provided by way of example and are not intended to limit the scope of the invention. The described embodiments comprise different features, not all of which are required in all embodiments of the invention. Some embodiments of the invention utilize only some of the features or possible combinations of the features. Variations of embodiments of the described invention and embodiments of the invention comprising different combinations of features than those noted in the described embodiments will occur to persons of the art. The scope of the invention is limited only by the following claims.

1. A liquid lithium jet nozzle comprising:
an inlet through which liquid lithium flows into the nozzle;
an inlet flow channel that receives liquid lithium that flows into the nozzle via the inlet and shapes the flowing liquid lithium to flow in a thin film having thickness less than or equal to about 3 mm; and
a flow region that receives flowing liquid lithium shaped by the flow channel and in which the liquid lithium flows with a surface of the film exposed.

2-8. (canceled)

9. A liquid lithium jet nozzle according to claim 27 wherein area of a cross section of the inlet flow channel perpendicular to a direction of flow of liquid lithium in the flow channel decreases with distance from the inlet along a flow path of liquid lithium in the nozzle.

10-12. (canceled)

13. A liquid lithium jet nozzle according to claim 1 wherein thickness of the film is less than or equal to about 2 mm.

14. A liquid lithium jet nozzle according to claim 1 wherein thickness of the film is less than or equal to about 1 mm.

15. A liquid lithium jet nozzle according to claim 1 wherein thickness of the film is less than or equal to about 100 μm.

16. A liquid lithium jet nozzle according to claim 1 wherein thickness of the film is less than or equal to about 50 μm.

17. A liquid lithium jet nozzle according to claim 1 wherein thickness of the film is less than or equal to about 20 μm.

18. A liquid lithium jet nozzle according to claim 1 wherein thickness of the film is equal to about 10 μm.

19. A liquid lithium target system comprising:
a jet nozzle according to claim 1;
and a liquid lithium pump for pumping liquid lithium to the inlet of the jet nozzle.

20. A liquid lithium target system according to claim 19 wherein the pump pumps liquid lithium so that it flows through the flow region at a flow rate equal to or greater than about 20 m/s.

21. A liquid lithium target system according to claim 19 wherein the pump pumps liquid lithium so that it flows through the flow region at a flow rate equal to or greater than about 25 m/s.

22. A liquid lithium target system according to claim 19 wherein the pump pumps liquid lithium so that it flows through the flow region at a flow rate equal to or greater than about 30 m/s.

23. A neutron factory for producing neutrons by interaction of accelerated ions with liquid lithium, the neutron factory comprising:
a liquid lithium target system according to claim 19;
and an accelerator that generates a beam of ions that is incident on liquid lithium flowing in the flow region of the jet nozzle.

24. A neutron factory according to claim 23 wherein the accelerator comprises a linear accelerator.

25. A neutron factory according to claim 23 wherein the beam has intensity equal to or greater than about 3 mA.

26. A neutron factory according to claim 23 wherein the beam has intensity equal to or greater than about 5 mA.

27. A liquid lithium jet nozzle comprising:
an inlet through which liquid lithium flows into the nozzle;
an inlet flow channel that receives liquid lithium that flows into the nozzle via the inlet and shapes the flowing liquid lithium to flow in a thin film and wherein a dimension of a cross section of the inlet flow channel perpendicular to a direction of flow of liquid lithium in the flow channel increases with distance from the inlet along a flow path of liquid lithium in the nozzle; and
a flow region that receives flowing liquid lithium shaped by the flow channel and in which the liquid lithium flows with a surface of the film exposed.
